(19) United States
(12) Patent Application Publication
(10) Pub. No.: US 2010/0070998 A1
(43) Pub. Date: Mar. 18, 2010

(54) SET-TOP BOX AND PROGRAM BROWSING METHOD THEREOF

(75) Inventors: Yong Miao, Shenzhen City (CN); Yan-Zhi Wang, Shenzhen City (CN); Po-Chin Chen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (Shenzhen) CO., LTD., Shenzhen City (CN); HON HAI PRECISION INDUSTRY CO., LTD., Tu-Cheng (TW)

(21) Appl. No.: 12/408,735

(22) Filed: Mar. 23, 2009

(30) Foreign Application Priority Data
Sep. 16, 2008 (CN) 200810304524.4

(51) Int. Cl. H04N 5/445; H04N 7/16

(52) U.S. Cl. 725/38; 725/151

(57) ABSTRACT

A set-top box (STB) includes a memory, a first tuner, a second tuner, and a decoder. The first tuner is configured for playing a current program on a current channel when in play mode, and for locking one or more subsequent channels after the current channel, and storing the intra frames from the programs on the subsequent channels in the memory when in browse mode. The second tuner is configured for storing the intra frames from the favorite programs in the memory when in play mode, and for storing the intra frame from the current program on the current channel in the memory when in browse mode. The decoder is configured for decoding the current program on the current channel into video and audio when in play mode, and for decoding the intra frames from the favorite programs in memory into images when in browse mode. A digital information system and a program browsing method are also provided.

### BACKGROUND

1. Technical Field

Embodiments of the disclosure relate to home network communications, and more particularly to a set-top box and a program browsing method employed thereby.

2. Description of Related Art

With the rapid development of digital television technologies, thousands of programs are made available to users via wired networks, inflating user choice to a maximum. Generally, a controller allows browsing of programs from a channel list before watching. Due to the sheer numbers of the programs, channels must be switched frequently, an inconvenient and time-wasting operation. In addition, the television program schedules can make location of desired programs inconvenient and slow.

### BRIEF DESCRIPTION OF THE DRAWINGS

FIG. 1 is a schematic diagram of an application environment and functional modules of a set-top box in accordance with the disclosure;

FIG. 2 is a schematic diagram of a set-top box in a play mode in accordance with the disclosure;

FIG. 3 is a schematic diagram of a set-top box in a browse mode in accordance with the disclosure; and

FIG. 4 is a flowchart of a program browsing method in accordance with the disclosure.

### DETAILED DESCRIPTION OF CERTAIN INVENTIVE EMBODIMENTS

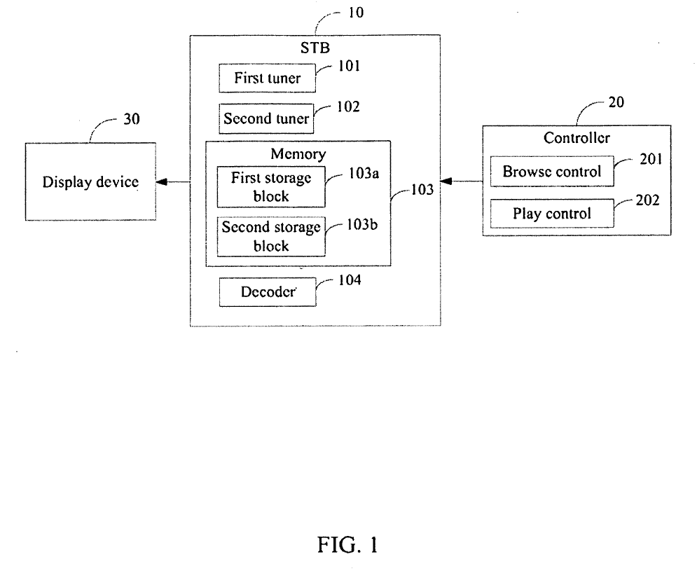

FIG. 1 is a schematic diagram of an application environment of a set-top box (STB) 10 according to the disclosure. Here, the STB 10 is applied in a digital information system including a controller 20 and a display device 30. The STB 10 functions in play and browse modes. Controller 20 includes a browse control 201 and a play control 202. Both modes of the STB 10 can be alternated by use of the appropriate control. Programs played by the STB 10 are viewed on display device 30, which can be a television, liquid crystal display (LCD), or other device.

Here, the STB 10 includes a first tuner 101, a second tuner 102, a memory 103, and a decoder 104.

The first tuner 101 plays a program on a current channel when in play mode, locks subsequent channels after the current channel, extracting intra frames (I-frame) of programs of the subsequent channels, and stores the intra frames in the memory 103 when in browse mode.

The second tuner 102 collects one or more favorite programs, extracts intra frames therefrom, stores the intra frames in the memory 103 when in play mode, and locks the current channel, extracting an intra frame from the current program of the current channel in the memory 103 when in browse mode.

The decoder 104 decodes the current program on the current channel into video and audio when in play mode, and decodes the intra frames of the favorite programs in memory 103 into images when in browse mode.

The display device 30 displays the decoded images.

Preferably, the memory 103 comprises a first storage block 103a and a second storage block 103b. The first storage block 103a stores the intra frames of the favorite programs when in play mode and intra frames from the programs of the subsequent channels when in browse mode. The second storage block 103b is configured stores the intra frames of the current program when in browse mode.

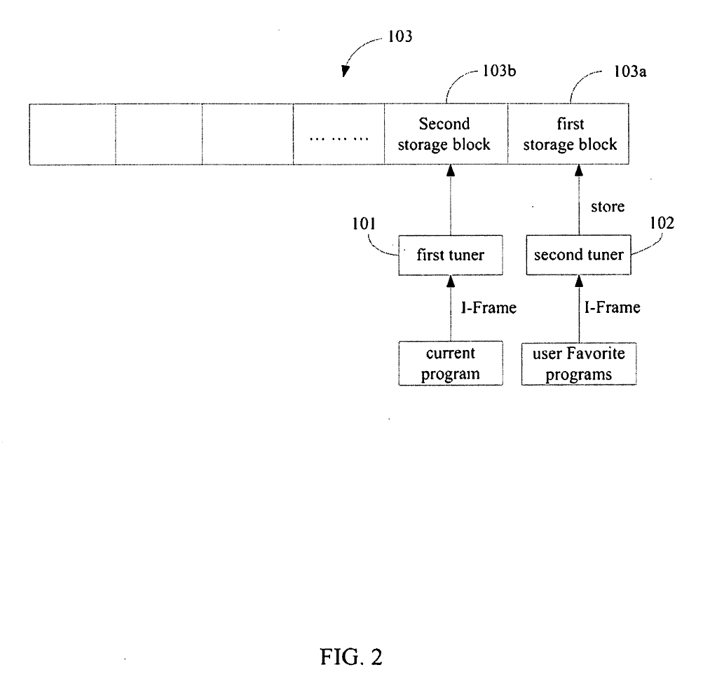

FIG. 2 is a schematic diagram of the STB 10 in play mode. Accordingly, the first tuner 101 of the STB 10 plays a program on the current channel, and the second tuner 102 collects one or more favorite programs, extracts intra frames thereof, and stores the intra frames to the first storage block 103a of the memory 103. The second tuner 102 updates the intra frames continuously. Here, the memory 103 is a random access memory (RAM).

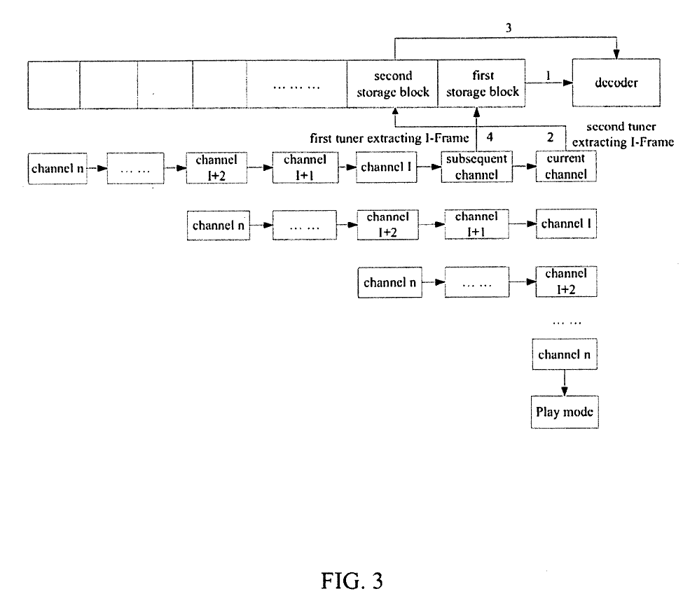

FIG. 3 is a schematic diagram of the STB 10 in browse mode. When in browse mode, the decoder 104 decodes the intra frame in the first storage block 103a into images. The second tuner 102 locks the current channel, extracts intra frames from the favorite programs and stores the intra frames in the second storage block 103b of the memory 103. The first tuner 101 locks the subsequent channel after the current channel, extracts the intra frames of programs of the subsequent channels after the current channel and stores the intra frames from the programs of the subsequent channels in the first storage block 103a of the memory 103.

Here, the controller 20 comprises the browse mode control 201 and the play mode control 202. The STB 10 enters the browse mode when the browse mode control 201 is activated, and plays the current program by use of the display device 30 when the play mode control 202 is activated. Alternatively, the controller 20 may further comprise a page-up control and a page-down control, whereby previous and subsequent pages are respectively viewable corresponding to activation thereof.

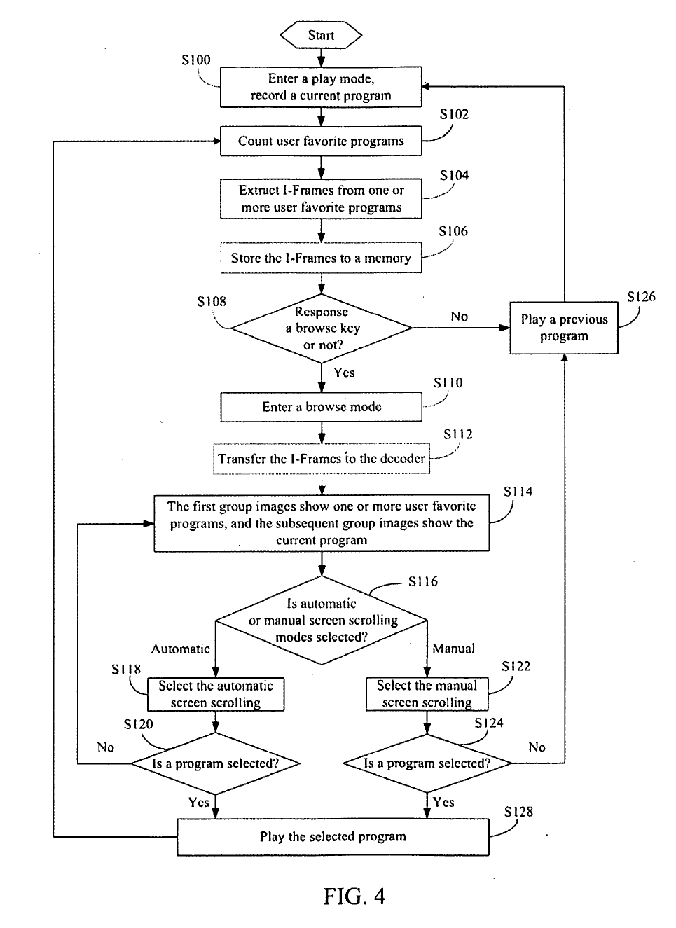

FIG. 4 is a flowchart of a program browsing method. Here, the program browsing method is implemented via the STB 10 in FIG. 1.

In block S100, the STB 10 boots up, and enters play mode. The first tuner 101 plays and recodes a current program.

In block S102, the STB 10 records the favorite, and distributes part to the storage block of the memory 103.

In block S104, the second tuner 102 extracts intra frames from the favorite programs.

In block S106, the second tuner 102 stores the intra frames in the memory 103 and updates the intra frames instantaneously.

In block S108, the STB 10 determines whether the browse control 201 is activated. If so, the STB 10 enters the browse mode (in block S110). If the browse control 201 is not activated, in block S126, the STB 10 displays the previous programs, and then block S100 is repeated.

In block S112, the STB 10 transfers the stored intra frames of the memory 103 to the decoder 104, and video and audio are played corresponding to the intra frames on the display device 30 after the decoder 104 decodes the intra frames to images and audio. STB 10 releases blocks of the memory 103 necessary to store the intra frames. The second tuner 102 locks the current channel, extracts one intra frame of a current program, and stores the extracted intra frame in the memory 103. The first tuner 101 locks the subsequent channel, extracts one intra frame from each program of the subsequent channel, and stores the extracted intra frame in the memory 103.

In block S114, the STB 10 displays the favorite programs on a current screen of the display device 30, and displays the program on the current channel on a subsequent screen of the display device 30.

In block S116, automatic and manual display scrolling modes are made available. In block S118, the automatic scrolling mode is selected. In block S122, the manual scrolling mode is selected.

In block S120, the controller 20 determines whether a program has been selected. If so, in block S128, the STB 10 plays the selected program via the display device 30. If not, block S114 is repeated.

In block S124, the controller 20 determines whether a program has been selected. If so, in block S128, the STB 10 plays the selected program via the display device 30. If not, block S126 is repeated.

Here, the program browsing method initiates the STB 10 in browse mode by way of browse control 201. The display device 30 shows favorite programs, if browse control 201 is activated.

Although the features and elements of the disclosure are described as embodiments in particular combinations, each feature or element can be used alone or in other various combinations within the principles of the disclosure to the full extent indicated by the broad general meaning of the terms in which the appended claims are expressed.

What is claimed is:

1. A set-top box capable of operating in browse mode and play mode, comprising:
a memory configured for storing inter frames from programs;
a first tuner configured for playing a current program on a current channel when in play mode, and for locking one or more subsequent channels after the current channel, extracting intra frames from programs on the one or more subsequent channels, and storing the intra frames from the program of the subsequent channel in the memory when in browse mode;
a second tuner configured for recording one or more favorite programs, extracting intra frames of the favorite programs, and storing the intra frames of the favorite programs in the memory when in play mode, and for locking the current channel, extracting an intra frame from the current program on the current channel, and storing the intra frame from the current program on the current channel in the memory when in browse mode; and p1 a decoder configured for decoding the current program on the current channel into video and audio when in play mode, and for decoding the intra frames of the favorite programs in memory into images when in browse mode.

2. The set-top box as claimed in claim 1, wherein the memory comprises a first storage block and a second storage block, wherein the first storage block stores the intra frames from the favorite programs when in play mode and storing the intra frames from the program on the subsequent channels after the current channel when in browse mode, and the second storage block stores the intra frame from the current program on the current channel when in browse mode.

3. A program browsing method of a set-top box comprising a memory, a first tuner, a second tuner and a decoder, the method comprising:
the set-top box entering a play mode;
the first tuner playing a current program;
the second tuner recording one or more statistics regarding favorite programs, extracting intra frames from the favorite programs, and storing the intra frames to the memory;
the set-top box entering browse mode;
the second tuner locking a current channel, extracting the intra frame from the current program of the current channel and storing the intra frame from the current program of the current channel in the memory;
the first tuner locking subsequent channels after the current channel, extracting intra frames from programs in the subsequent channel after the current channel and storing the intra frames from the programs in the subsequent channels in the memory; and
the decoder decoding the intra frames in the memory into images.

4. The program browsing method as claimed in claim 3, further comprising:
the tuner displaying images of the decoded intra frames from the favorite programs, and subsequently displaying images of the decoded current program when in browse mode.

5. The program browsing method as claimed in claim 4, further comprising selecting a favorite program using a controller when in browse mode.
